(19) United States
(12) Patent Application Publication
(10) Pub. No.: US 2007/0119973 A1
(43) Pub. Date: May 31, 2007

(54) Adjustable sprinkler nozzle

(76) Inventors: Hedwig Van Roy, Brasschaat (BE); Pieter Michielsen, Wijnegen (BE)

Correspondence Address: BACON & THOMAS, PLLC, 625 SLATERS LANE, FOURTH FLOOR, ALEXANDRIA, VA, 22314, US

(21) Appl. No.: 10/585,080

(22) PCT Filed: Nov. 18, 2004
(86) PCT No.: PCT/BE04/00165

§ 371 Date: Jun. 29, 2006

(30) Foreign Application Priority Data
Jan. 7, 2004 (BE) 2004/0006
Sep. 3, 2004 (BE) 2004/0433

(51) Int. Cl. B05B 15/06; E01H 3/04; A01G 25/06

(52) U.S. Cl. 239/200; 239/201; 239/202

(57) ABSTRACT

Sprinkler nozzle which is formed of two parts which each mesh into each other with one of their far ends and which are mutually connected by means of a snap system which makes it possible to lock both parts in different positions in relation to each other, whereby the first part (2) consists of a hollow body with a passage (5) which is or can be fixed to a spray cylinder (1), and whereby the second part (4) consists of a hollow body in which is provided a die channel (6), characterised in that the above-mentioned snap system is formed of two contact surfaces working in conjunction with each other, one of which is part of the first part (2) and consists of a multi-surfaced edge (9, 10, 11), and the other contact surface of which is part of the second part (4) and consists of a multi-surfaced ring (13, 14, 15) which is complementary to the above-mentioned multi-surfaced edge (9, 10, 11).

The invention concerns an adjustable sprinkler nozzle for a spray can or the like, more particularly a sprinkler nozzle as is used for example for distributing liquid silicones or the like from a spray can, a spray cylinder or the like.

Spray cylinders which are provided with an adjustable sprinkler nozzle are already known, for example, as described in DE 34,20,765 and DE 197,44,250.

A disadvantage of a sprinkler nozzle, as described in DE 34,20,765, is that the moving part of the sprinkler nozzle cannot be realised as a whole by means of injection moulding, since the inner mould which has to form the cavity of the moving part in the case of injection moulding, cannot be removed via the narrowed opening on the rotating far end of this part after the injection moulding. As a consequence, such a sprinkler nozzle is relatively expensive.

Another disadvantage of this sprinkler nozzle is that, when the sprinkler nozzle is in use, the moving part can turn as a result of the exerted pressure, such that it is no longer possible to work accurately, which is moreover awkward.

A disadvantage of a sprinkler nozzle, as described in DE 197,44,250, is that in the embodiment with a flexible part, this flexible part is pushed out of its folded position again, in the axial direction, due to the pressure of the silicones or the like, such that it is no longer possible to work accurately with this sprinkler nozzle either.

The other embodiment of a sprinkler nozzle according to this document cannot be produced in an economically profitable manner and moreover is disadvantageous in that the sprinkler nozzle can turn during the use as well.

The invention concerns an adjustable sprinkler nozzle whereby it is excluded that the sprinkler nozzle can turn while it is being used, and whose rotating part can be made as a whole.

To this end, the invention concerns a sprinkler nozzle which is formed of two parts which each mesh into each other with one of their far ends and which are mutually connected by means of a snap system which makes it possible to lock both parts in different positions in relation to each other, whereby the first part consists of a hollow body with a passage which is or can be fixed to a spray cylinder, and whereby the second part consists of a hollow body in which is provided a die channel, characterised in that the above-mentioned snap system is formed of two contact surfaces working in conjunction with each other, one of which is part of the first part and consists of a multi-surfaced edge, and the other contact surface of which is part of the second part and consists of a multi-surfaced ring which is complementary to the above-mentioned multi-surfaced edge.

The cross section of the die channel of the second part preferably stays the same or increases as of the free end of the second part towards the other far end of this second part.

An advantage of such an embodiment is that this second part can be made by means of a simple and relatively cheap mould by means of injection moulding.

Indeed, when the supporting area of the second part extends into the longitudinal channel, this supporting area forms a local constriction in the die channel which hampers the removal of a core from the mould, which serves as a counter mould for the die channel, or even makes this impossible, unless use is made of a mould with moving parts, which type of mould is usually relatively expensive.

The invention also concerns a spray cylinder which is provided with an adjustable sprinkler nozzle according to the invention.

Finally, the invention also concerns a method for manufacturing a sprinkler nozzle according to the invention, characterised in that this method consists of injection moulding a first material in a mould part in order to form the second part of the sprinkler nozzle; in making the second part cure; in injection moulding a second material in a second mould part which extends around the far end of the second part which has already been formed in order to form the first part of the sprinkler nozzle; and in making the first part cure, whereby the first material out of which the second part is made has a higher melting point than the second material out of which the first part is made.

In order to better explain the characteristics of the invention, the following preferred embodiment of an improved sprinkler nozzle according to the invention is described as an example only without being limitative in any way, with reference to the accompanying drawings, in which:

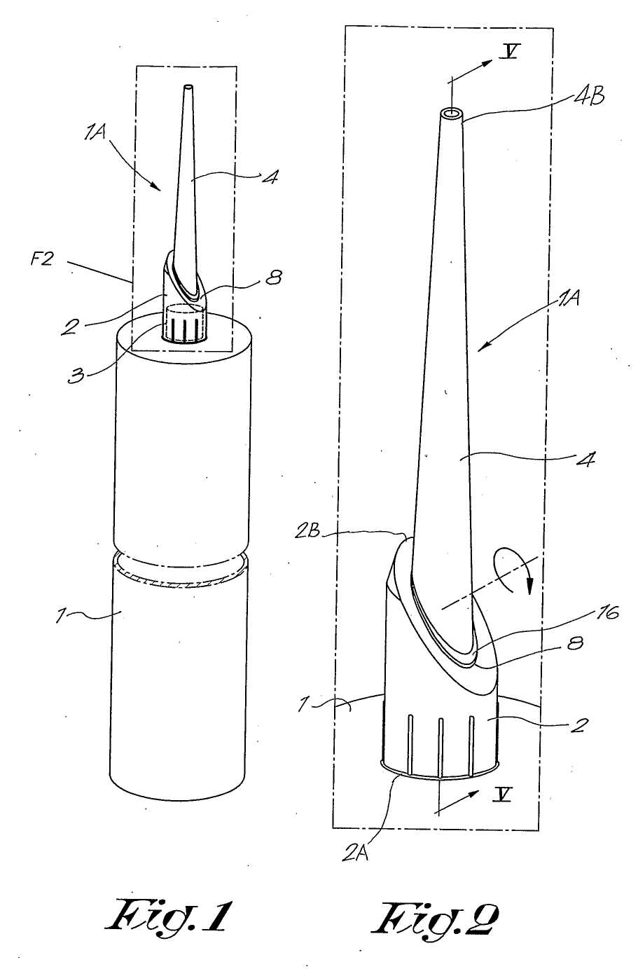

FIG. 1 shows a spray cylinder in perspective, provided with a sprinkler nozzle according to the invention;

FIG. 2 represents the part indicated by F2 in FIG. 1 to a larger scale;

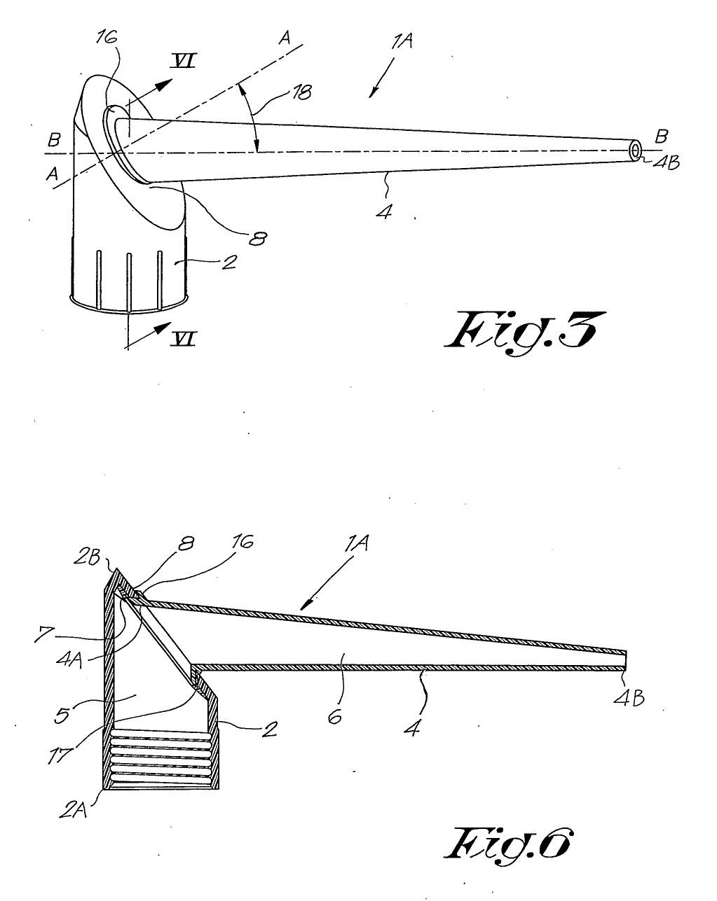

FIG. 3 represents the sprinkler nozzle of FIG. 2 after the die channel has been rotated;

FIG. 4 represents a view of the two parts of the sprinkler nozzle;

FIG. 5 represents a section according to line V-V in FIG. 2;

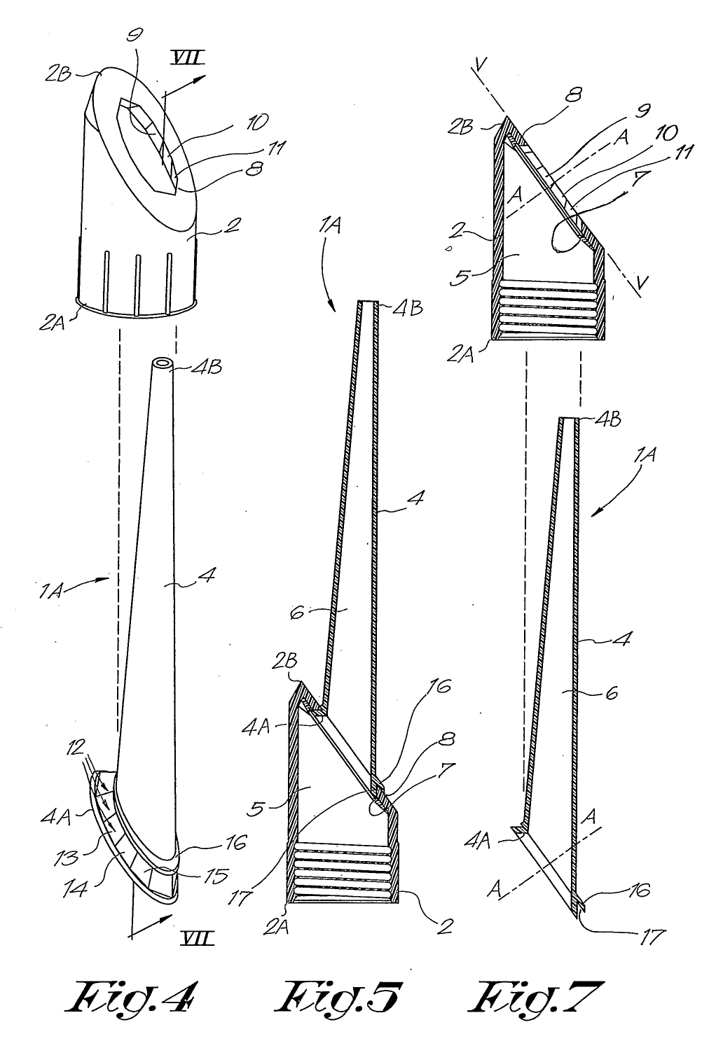

FIG. 6 represents a section according to line VI-VI in FIG. 3;

FIG. 7 represents a section according to line VII-VII in FIG. 4;

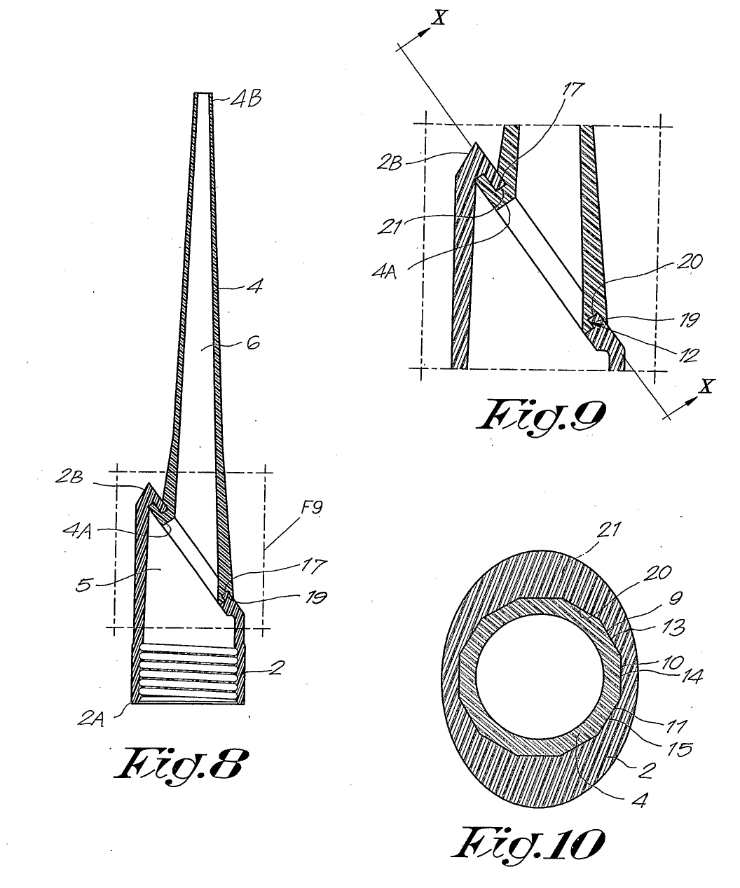

FIG. 8 represents a variant of FIG. 5;

FIG. 9 represents the part which is indicated by F9 in FIG. 8 to a larger scale;

FIG. 10 represents a section according to line X-X in FIG. 9.

The spray cylinder or spray can 1 according to FIG. 1 is provided with a sprinkler nozzle 1A.

This sprinkler nozzle 1A is formed of a first part 2 which, in this case, is designed to be screwed on a protrusion 3 of the spray cylinder 1 or spray can with one far end 2A, and a second part 4 which meshes in the far end 2B of the first part 2 in a rotating manner with one of its far ends 4A.

The first part 2 consists of a hollow body with a passage 5 provided in it between the internal, part of the spray cylinder 1 and a die channel 6 of the second part 4.

The first part 2 has a contact surface 7 on its far end 2B which is directed towards the passage 5 and a supporting area 8. The contact surface 7 in this case comprises at least an almost conical edge composed of several small surfaces 9, 10, 11, etc. situated next to each other.

The second part 4 in this case comprises an almost conical contact surface 12 on its far end 4A which meshes in the far end 2B of the first part 2, which is formed of a multi-surfaced ring of small surfaces 13, 14, 15, etc. situated next to each other, as well as a ring-shaped protrusion 16, whereby between this conical contact surface 12 and the protrusion 16 is defined a groove 17.

The above-mentioned conical edge of the contact surface 7 of the first part 2 is held in the above-mentioned groove 17, whereby the small surfaces 9, 10, 11 of the contact surface 7 work in conjunction with the small surfaces 13, 14 and 15 of the contact surface 12 of the second part 2 and thus form a snap system, whereby the contact surface 7 of the first part 2 is provided around the contact surface 12 of the second part 4.

As represented in FIG. 7, the contact surfaces 7 and 12 can rotate in relation to each other around an axis of rotation A-A which in this case is almost perpendicular to a face V-V which is formed by the above-mentioned supporting area 8, such that the sprinkler nozzle 1A can be adjusted by means of rotation.

The universal joint is provided with several small surfaces which make it possible to lock the rotating part in different positions, more particularly according to different angles.

Thanks to this multi-surfaced universal joint, the angle 18 can be altered in steps in relation to the axis of rotation A-A. The multi-surfaced rotation prevents the set angle from rotating during the use. In case of a rotation of 180° from the starting position, the maximum angle is obtained.

The die channel 6 of the second part 2 has a longitudinal axis B-B which forms an angle 18 with the axis of rotation A-A, which angle 18 in the present embodiment amounts to about 45°, such that, after the second part 4 has rotated over 180° in relation to the axis A-A, the die channel 6 of the second part 2 is rotated over 90°, namely from the position in which the axis B-B of the die channel 6 is parallel to the axis of the first part 2. (FIG. 5) to a position in which the axis B-B is perpendicular to the axis (FIG. 6).

According to the invention, the cross section of the die channel 6 stays the same or increases in size as of the free end 4B of the second part 4 to the other free end 4A which meshes in the far end 2B of the first part 2.

The dimensions of the cross section of the channel, formed by the die channel 6 and the passage 5, preferably remain constant or increase as of the free end 4B of the second part 4.

A method for manufacturing a sprinkler nozzle 1A according to the invention is simple and as follows.

First, the second part 4 is made by means of injection moulding in a first mould part.

After the second part 4 has cured, the first part 2 of the sprinkler nozzle 1A is formed by injection-moulding a second material in a second mould part in which the far end 2A of the second part 2 of the sprinkler nozzle 1A is provided, such that the contact surface 7 of the first part 2 is formed in the groove 17 of the second part 4.

After the first part 2 has cured, the sprinkler nozzle 1A can finally be removed from the mould part or the mould parts.

In the above-described method, the first and second part 2, 4 of the sprinkler nozzle 1A are preferably made of different materials, whereby the melting temperature of the material out of which the second part 4 is made is higher than the temperature at which the second material is provided in the second mould part by means of injection moulding.

By the above-described different materials are also meant mixtures of materials having identical or practically identical base materials, but with a different mutual relation in which said different base materials are present.

FIGS. 8 to 10 represent a variant of a sprinkler nozzle 1A according to the invention, whereby the second part 4 is provided with a groove 17 and whereby the first part 2 is provided with a collar 19 which, in this case, is provided on the inner wall of an opening in the above-mentioned supporting area 8 and which is held in the above-mentioned groove 17.

According to the invention, the groove 17 is mainly situated outside the channel 6 of the second part 4, and the first part 2 meshes with its collar 19 on the second part 4 along its outer side, such that the channel 6 does not narrow from a top 20 of the second part 4 to the supporting area 12.

In this variant, the above-mentioned snap system is situated between the above-mentioned groove 17 and collar 19 and is formed of several small surfaces 9 to 11 on the crosscut edge 20 of the above-mentioned collar 19 on the one hand, and of several small surfaces 13 to 15 on the bottom wall 21 of the above-mentioned groove 17 on the other hand.

An advantage of this variant is that the connection between both parts 2 and 4 can be made very rigid, such that both parts stay connected even in case of a very high pressure.

In the latter variant, it is also possible to provide the snap system between the inner wall of the first part 2 and the crosscut edge of a ring-shaped protrusion of the second part 4 which meshes behind the collar 19 of the supporting area 8.

It should be noted that the above-mentioned small surfaces 9 to 11 and 13 to 15 can be replaced by cross ridges in this variant.

Further, it should be noted that it is also possible to realise a sprinkler nozzle 1A according to the invention in one piece with a spray cylinder 1 concerned, which is advantageous in that the sprinkler nozzle 1A cannot get lost when storing the spray cylinder 1.

It is clear that the present invention is by no means limited to the above-described embodiment represented in the accompanying drawings; on the contrary, such an improved sprinkler nozzle according to the invention can be made in all sorts of shapes and dimensions while still remaining within the scope of the invention.

1. Sprinkler nozzle, comprising two parts which each mesh into each other with one of their far ends and which are mutually connected by means of a snap system which makes it possible to lock both parts in different positions in relation to each other, wherein the first part comprises a hollow body with a passage which is fixable to a spray cylinder, and wherein the second part comprises a hollow body in which is provided a die channel, wherein the snap system comprises two contact surfaces working in conjunction with each other, one of which is part of the first part and comprises a multi-surfaced edge, and the other contact surface is part of the second part and comprises a multi-surfaced ring which is complementary to the above-mentioned multi-surfaced edge.

2. Sprinkler nozzle according to claim 1, wherein the multi-surfaced edge of the first part is disposed around the multi-surfaced ring of the second part.

3. Sprinkler nozzle according to claim 1, wherein the cross section of the die channel of the second part stays the same or increases from a free end thereof relative to its opposed end that is lockable to the first part.

4. Sprinkler nozzle according to claim 3, wherein the dimensions of the cross section of the channel, formed by the die channel and the passage, stay the same or increase relative to the free end of the second part.

5. Sprinkler nozzle according to claim 1, wherein the multi-surfaced edge and the multi-surfaced ring are conical.

6. Sprinkler nozzle according to claim 5, wherein the second part is provided with a ring-shaped protrusion which, together with the multi-surfaced ring, defines a groove in which the multi-surfaced edge of the first part is held.

7. Sprinkler nozzle according to claim 1, wherein the second piece is provided with a groove and the first piece is provided with a collar placed in this groove.

8. Sprinkler nozzle according to claim 7, wherein the multi-surfaced edge is formed of several small surfaces provided on the cross-cut edge of the collar and the multi-surfaced ring is formed of several small surfaces on the bottom wall of the groove.

9. Sprinkler nozzle according to claim 1, wherein the first part comprises a material with a melting temperature which is lower than the melting temperature of the material out of which the second part is made.

10. Sprinkler nozzle according to claim 1, wherein it is made in one piece with a spray cylinder.

11. Spray cylinder, comprising a sprinkler nozzle according to claim 1.

12. Method for manufacturing a sprinkler nozzle recited in claim 1, comprising injection moulding a first material in a mould part in order to form the second part of the sprinkler nozzle; curing the second part; injection moulding a second material in a second mould part which extends around the far end the second part which has already been formed in order to form the first part of the sprinkler nozzle; and curing the first part wherein the first material out of which the second part is made has a higher melting point than the second material out of which the first part is made.
